(19) United States
(12) Patent Application Publication
(10) Pub. No.: US 2013/0191128 A1
(43) Pub. Date: Jul. 25, 2013

(54) CONTINUOUS PHONETIC RECOGNITION METHOD USING SEMI-MARKOV MODEL, SYSTEM FOR PROCESSING THE SAME, AND RECORDING MEDIUM FOR STORING THE SAME

(71) Applicants: Chang Dong Yoo, Daejeon (KR); Sung Woong Kim, Daejeon (KR)

(72) Inventors: Chang Dong Yoo, Daejeon (KR); Sung Woong Kim, Daejeon (KR)

(73) Assignee: KOREA ADVANCED INSTITUTE OF SCIENCE AND TECHNOLOGY, Daejeon (KR)

(21) Appl. No.: 13/596,821

(22) Filed: Aug. 28, 2012

(30) Foreign Application Priority Data
Jan. 20, 2012 (KR) 10-2012-0006898

(51) Int. Cl. G10L 15/04

(52) U.S. Cl. 704/254; 704/E15.005

(57) ABSTRACT

A continuous phonetic recognition method using semi-Markov model, a system for processing the method, and a recording medium for storing the method. In and embodiment of the phonetic recognition method of recognizing phones using a speech recognition system, a phonetic data recognition device receives speech, and a phonetic data processing device recognizes phones from the received speech using a semi-Markov model.

### CROSS-REFERENCES TO RELATED APPLICATIONS

This patent application claims the benefit of priority from Korean Patent Application No. 10-2012-0006898, filed on Jan. 20, 2012, the contents of which are incorporated herein by reference in its entirety.

### BACKGROUND OF THE INVENTION

1. Field of the Invention

The present invention relates, in general, to a phonetic recognition method, system and recording medium for recognizing phones from speech signals and, more particularly, to a continuous phonetic recognition method that uses a semi-Markov model for reducing an error rate in phonetic recognition, to a system for processing the method, and to a recording medium for storing the method.

2. Description of the Related Art

Phonetic recognition technology is technology for causing devices, such as computers, to comprehend the speech of human beings, and is configured to pattern the speech (signals) of human beings and determine how the patterned speech is similar to patterns previously stored in computers or the like.

In the modern age, such technology is regarded as a very important issue when being applied to advanced devices, such as smart phones or navigation terminals. Recently, as an environment in which input devices, such as a keyboard, a touch screen, or a remote control, are used is also diversified, the case where such an input device results in inconvenience occurs.

Generally, a Hidden Markov Model (HMM) has been used to recognize phones. The HMM is obtained by statistically modeling phonetic units, such as phones or words, and the data and contents of the HMM are well known in the art.

FIG. 1 is a diagram showing a Hidden Markov Model (HMM). Referring to FIG. 1, an HMM is configured such that the frame features x={x₁, . . . , x_{T}} appear in the form of a frame-based structure composed of frames having regular short lengths. The HMM predicts a phonetic label y={l₁, l₂, . . . , l_{T}} for observation in each frame without requiring explicit phone segmentation. For example, when “have” is uttered, a phonetic label is set for each frame, as shown in FIG. 1.

However, the HMM most widely used in phonetic recognition at the present time predicts phonetic labels for respective observations (frames) without performing explicit phone segmentation, on the assumption that only local statistical dependencies are present between neighboring observations (frames). That is, such an HMM is problematic in that there is a high error rate in continuous phonetic recognition because long-range dependencies are not taken into consideration.

### SUMMARY OF THE INVENTION

Accordingly, the present invention has been made keeping in mind the above problems occurring in the prior art, and an object of the present invention is to provide a continuous phonetic recognition method that uses a semi-Markov model for speech recognition in which both continuous phonetic recognition and an error rate are taken into consideration, a system for processing the method, and a recording medium for storing the method.

In accordance with an aspect of the present invention, there is provided a phonetic recognition method of recognizing phones using a speech recognition system, including by a phonetic data recognition device, receiving speech; and by a phonetic data processing device, recognizing phones from the received speech using a semi-Markov model.

Preferably, in the recognizing the phones, a phonetic label sequence may be represented by <function 1> given by the following equation:

$$\hat{y} = arg {max}_{y ∈ Y} F ( X , y ; w ) = arg {max}_{y ∈ Y} 〈 w , φ ( x , y ) 〉 \qquad 〈 function 1 〉$$

where ŷ denotes a phonetic label sequence, Y denotes a set of phonetic label sequences, x denotes an acoustic feature vector, y denotes a phonetic label, w denotes a parameter, and φ(x, y) denotes a segment-based joint feature map.

Preferably, the segment-based joint feature map may include:

$$\begin{matrix}Φ ( X , y ) = {\sum }_{j = 1}^{J} φ ( {l}_{j - 1} , {l}_{j} , {n}_{j - 1} , {n}_{j} , {\{ x \}}_{j} ) \\ = {\sum }_{j = 1}^{J} [ \begin{matrix}\begin{matrix}{φ}^{transition} ( {l}_{j - 1} , {l}_{j} ) \\ {φ}^{duration} ( {n}_{j - 1} , {n}_{j} , {l}_{j} )\end{matrix} \\ {φ}^{content} ( {\{ x \}}_{j} , {n}_{j - 1} , {n}_{j} , {l}_{j} )\end{matrix} ]\end{matrix}$$

where lⱼ denotes a label of a j-th phone segment, nⱼ denotes a last frame index of the j-th phone segment, J denotes a number of segments, {x}ⱼ denotes an acoustic feature vector of observation of the j-th phone segment, φ^{transition}(lⱼ₋₁, lⱼ) denotes a transition feature indicating a relationship between a relevant phone and its subsequent phone when the relevant phone is present on a just previous label, φ^{duration}(nⱼ₋₁, nⱼ, lⱼ) denotes a (nⱼ₋₁-nⱼ) duration feature indicating a duration of the relevant phone (for example, for the label lⱼ), and φ^{content}({x}ⱼ, nⱼ₋₁, nⱼ, lⱼ) denotes a content feature indicating acoustic feature data.

Preferably, the transition feature may be represented by a Kronecker delta function, and the duration feature may be defined as sufficient statistics of gamma distribution.

Preferably, the content feature may be represented by the following equation:

$${φ}_{( l , k )}^{content} ( {\{ x \}}_{j} , {n}_{j - 1} , {n}_{j} , {l}_{j} ) = \frac{B ( l )}{{n}_{j} - {n}_{j - 1}} {\sum }_{t ∈ {s}_{j , k}} vec ( [ \begin{matrix}{x}_{t} {x}_{t}^{T} & {x}_{t} \\ {x}_{t}^{T} & 1\end{matrix} ] ) δ ( {l}_{j} = l )$$

where l denotes a phone, k denotes a bin index, B(l) denotes a number of bins corresponding to a phonetic label l, bₖ is

$${b}_{k} = \{ {n}_{j - 1} + \frac{{n}_{j} - {n}_{j - 1}}{B ( l )} ( k - 1 ) + 1 , … , {n}_{j - 1} + \frac{{n}_{j} - {n}_{j - 1}}{B ( l )} k \}$$

(where kε{1, . . . , B(l)}), and δ(lⱼ=l) denotes a Kronecker delta function.

Preferably, the parameter w may be estimated by a Structured Support Vector Machine (S-SVM), and the S-SVM may be solved using a stochastic subgradient descent algorithm.

In accordance with another aspect of the present invention, there is provided a speech recognition system for recognizing phones, including a phonetic data recognition device for receiving speech, configuring speech data from the speech, and outputting the speech data; and a phonetic data processing device for recognizing phones from output signals of the phonetic data recognition device using a semi-Markov model.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a Hidden Markov Model (HMM);

FIG. 2 is a diagram showing a speech recognition system according to an embodiment of the present invention;

FIG. 3 is a diagram showing a semi-Markov model corresponding to a phonetic recognition model according to an embodiment of the present invention;

FIGS. 4 and 5 are diagrams showing a better understanding of the phonetic recognition model according to the embodiment of the present invention;

FIGS. 6 and 7 are diagrams showing an error rate when the phonetic recognition model according to the embodiment of the present invention is used; and

FIG. 8 is a flowchart showing a phonetic recognition method according to an embodiment of the present invention.

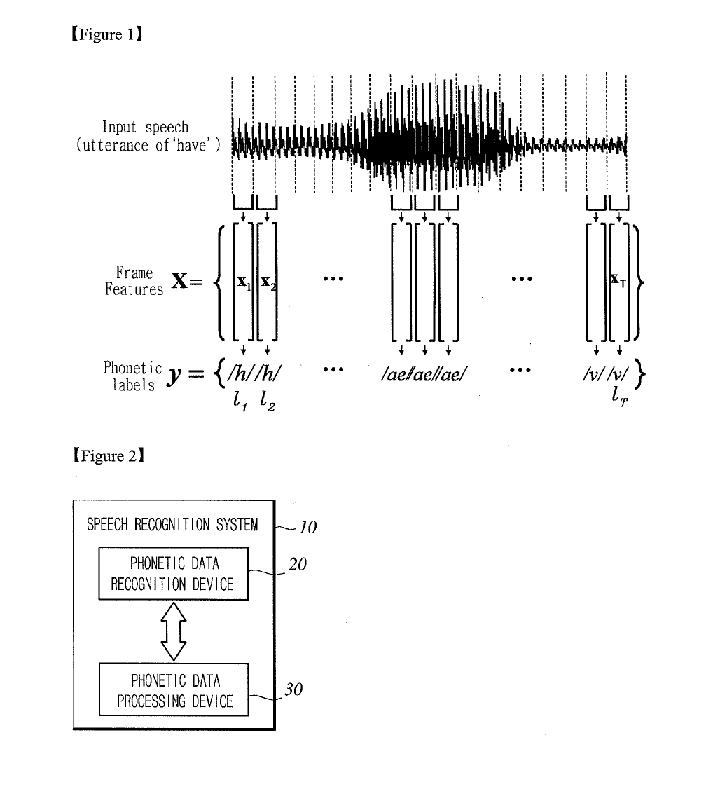

### DESCRIPTION OF THE PREFERRED EMBODIMENTS

Specific structural or functional descriptions related to embodiments based on the concept of the present invention and disclosed in the present specification or application are merely illustrated to describe embodiments based on the concept of the present invention, and the embodiments based on the concept of the present invention may be implemented in various forms and should not be interpreted as being limited to the above embodiments described in the present specification or application.

The embodiments based on the concept of the present invention may be modified in various manners and may have various forms, so that specific embodiments are intended to be illustrated in the drawings and described in detail in the present specification or application. However, it should be understood that those embodiments are not intended to limit the embodiments based on the concept of the present invention to specific disclosure forms and they include all changes, equivalents or modifications included in the spirit and scope of the present invention.

The terms such as “first” and “second” may be used to describe various components, but those components should not be limited by the terms. The terms are merely used to distinguish one component from other components, and a first component may be designated as a second component and a second component may be designated as a first component in the similar manner, without departing from the scope based on the concept of the present invention.

Throughout the entire specification, it should be understood that a representation indicating that a first component is “connected” or “coupled” to a second component may include the case where the first component is connected or coupled to the second component with some other component interposed therebetween, as well as the case where the first component is “directly connected” or “directly coupled” to the second component. In contrast, it should be understood that a representation indicating that a first component is “directly connected” or “directly coupled” to a second component means that no component is interposed between the first and second components.

Other representations describing relationships among components, that is, “between” and “directly between” or “adjacent to,” and “directly adjacent to,” should be interpreted in similar manners.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Further, the same characters are interpreted as having the same meaning. Even in the case of different characters, they have commonness for objects meant by subscripts. Hereinafter, the present invention will be described in detail based on preferred embodiments of the present invention with reference to the attached drawings. The same characters have the same meaning.

FIG. 2 is a diagram showing a speech recognition system according to an embodiment of the present invention. Referring to FIG. 2, a speech recognition system 10 includes a phonetic data recognition device 20 and a phonetic data processing device 30.

The phonetic data recognition device 20 recognizes phonetic data and is configured to, for example, receive speech, such as human speech, configure speech data from the speech, and output the speech data to the phonetic data processing device 30.

The phonetic data processing device 30 performs processing such that phones can be exactly recognized from the speech data received from the phonetic data recognition device 20 using a phonetic recognition model (or algorithm) according to the present invention. The phonetic recognition model according to the present invention will be described in detail bellow.

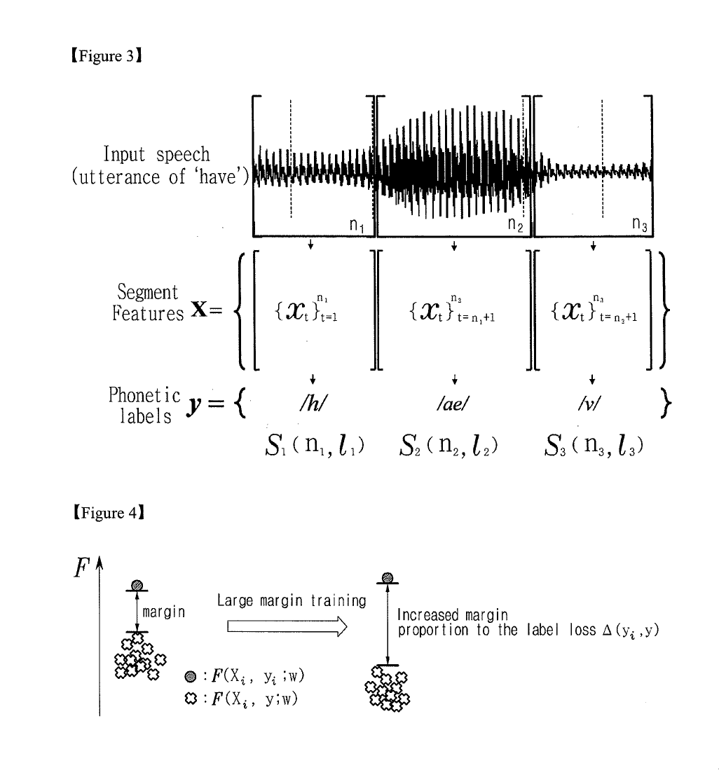

FIG. 3 is a diagram showing a phonetic recognition model corresponding to a semi-Markov model according to an embodiment of the present invention. Referring to FIG. 3, the phonetic recognition model corresponding to the semi-Markov model according to the present invention uses segment-based features because it simultaneously detects the boundaries of phone segments and relevant phonetic labels using a segment-based structure, unlike the HMM.

The phonetic recognition model according to the present invention captures long-range statistical dependencies in a single segment and adjacent segments having various lengths and to predict a phonetic label sequence y={s₁(n₁, l₁), s₂(n₂, l₂), s₃(n₃, l₃)} by performing labeling based on the segments, where sⱼ denotes a j-th segment, lⱼ denotes the label of a j-th phone segment, and nⱼ denotes the last frame index of the j-th phone segment.

For example, in FIG. 3, on the assumption that three segments have four, six, and four frames, respectively, when “have” is uttered, phonetic labels are set for the three segments. In this case, when an utterance of “have” is divided into “h”, “ae”, and “v”, the segments s₁, s₂, and s₃ may be (4,h), (10,ae), and (14,v), respectively.

Phonetic recognition may be performed via a task for converting speech (for example, human speech) into a phonetic label sequence. The phonetic label sequence may be represented by the following Equation (1):

$$\hat{y} = arg {max}_{y ∈ y} F ( X , y ; w ) = arg {max}_{y ∈ y} 〈 w , φ ( x , y ) 〉 \qquad ( 1 )$$

where ŷ denotes a phonetic label sequence, y denotes a set of phonetic label sequences, x denotes an acoustic feature vector, y denotes a phonetic label, w denotes a parameter, and φ(x, y) denotes a segment-based joint feature map. The above Equation (1) may be solved using the definition of the segment-based joint feature map and the determination of the parameter w.

The segment-based joint feature map is given by the following Equation (2):

$$\begin{matrix}Φ ( X , y ) = {\sum }_{j = 1}^{J} φ ( {l}_{j - 1} , {l}_{j} , {n}_{j - 1} , {n}_{j} , {\{ x \}}_{j} ) \\ = {\sum }_{j = 1}^{J} [ \begin{matrix}\begin{matrix}{φ}^{transition} ( {l}_{j - 1} , {l}_{j} ) \\ {φ}^{duration} ( {n}_{j - 1} , {n}_{j} , {l}_{j} )\end{matrix} \\ {φ}^{content} ( {\{ x \}}_{j} , {n}_{j - 1} , {n}_{j} , {l}_{j} )\end{matrix} ]\end{matrix} \qquad ( 2 )$$

where lⱼ denotes the label of the j-th phone segment, nⱼ denotes the last frame index of the j-th phone segment, and J denotes the number of segments. The above three features (transition feature, duration feature, and content feature) are defined as follows.

φₜᵣₐₙₛᵢₜᵢₒₙ(lⱼ₋₁, lⱼ) denotes a transition feature indicating a relationship between a certain phone and its subsequent phone when the certain phone is present on a just previous label.

The transition feature is used to capture statistical dependencies between two neighboring phones and may be represented by a Kronecker delta function, that is, δ(lⱼ₋₁=l′, lⱼ=l).

The Kronecker delta function has a value of 1 when lⱼ₋₁=l′ and lⱼ=l are satisfied; otherwise it has a value of 0.

φ^{duration}(nⱼ₋₁, nⱼ, lⱼ) denotes a (nⱼ₋₁-nⱼ) duration feature indicating the duration of a relevant phone (for example, for the phonetic label lⱼ), and is represented by the following Equation (3):

$${φ}_{l}^{duration} ( {n}_{j - 1} , {n}_{j} , {l}_{j} ) = [ \begin{matrix}log ( {n}_{j} - {n}_{j - 1} ) \\ {n}_{j} - {n}_{j - 1} \\ 1\end{matrix} ] δ ( {l}_{j} = l ) \qquad ( 3 )$$

The duration feature for the phone l is defined as the sufficient statistics of gamma distribution. For example, in the case of speech “have,” the duration feature (simply indicated by φ^{d}) may be represented by φ^{d}=[(φ_{/h/}^{d})^{T}, (φ_{/ae/}^{d})^{T}, . . . ]^{T}.

φ^{content}({x}ⱼ, nⱼ₋₁, nⱼ, lⱼ) denotes a content feature indicating acoustic feature data, and is represented by the following Equation (4):

$${φ}_{( l , k )}^{content} ( {\{ x \}}_{j} , {n}_{j - 1} , {n}_{j} , {l}_{j} ) = \frac{B ( l )}{{n}_{j} - {n}_{j - 1}} {\sum }_{t ∈ {s}_{j , k}} vec ( [ \begin{matrix}{x}_{t} {x}_{t}^{T} & {x}_{t} \\ {x}_{t}^{T} & 1\end{matrix} ] ) δ ( {l}_{j} = l ) \qquad ( 4 )$$

where l denotes a phone, k denotes a bin index, and B(l) denotes the number of bins corresponding to the phonetic label l.

Further,

$${b}_{k} = \{ {n}_{j - 1} + \frac{{n}_{j} - {n}_{j - 1}}{B ( l )} ( k - 1 ) + 1 , … , {n}_{j - 1} + \frac{{n}_{j} - {n}_{j - 1}}{B ( l )} k \}$$

is satisfied, where kε{1, . . . , B(l)}.

For example, in the case of the speech “have,” the content feature (simply indicated by φ^{c}) may be represented by φ^{c}=[(φ_{(/h/,1)}^{c})^{T}, (φ_{(/h/,2)}^{c})^{T}, . . . , (φ_{(/ae/,1)}^{c})^{T}, (φ_{(/ae/,2)}^{c})^{T}, . . . ]^{T}.

That is, a single segment may be divided into a large number of bins having the same length. Thereafter, the Gaussian sufficient statistics of the acoustic feature vectors in the respective bins are averaged, and then the content feature can be defined. Different parameters w may be assigned to the respective bins.

Here, the SMM inference (Equation (1)) will be schematically described below.

Let V(t,l) be the maximal score for all partial segmentations such that the last segment ends at the t-th frame with label l, and let U(t,l) be a tuple of length d and previous label l′ occupied by the best path where phone l′ transits to phone l at time t-d. We derive the recursion of the dynamic programming for efficient SMM inference as;

$$U ( t , l ) = {argmax}_{( d , {l}^{′} ) ∈ \{ 1 , … , R ( l ) \} \times ℒ} ( V ( t - d , {l}^{′} ) + 〈 w , φ ( {l}^{′} , l , t - d , t , X ) 〉 )$$

$$V ( t , l ) = {max}_{( d , {l}^{′} ) ∈ \{ 1 , … , R ( l ) \} \times ℒ} ( V ( t - d , {l}^{′} ) + 〈 w , φ ( {l}^{′} , l , t - d , t , X ) 〉 )$$

where R(l) is the range of admissible durations of phone l to ensure tractable inference. Once the recursion reaches the end of the sequence, we traverse U(t,l) backwards to obtain segmentation information of the sequence. An implementation of the recursion in the above equations require O(T|L|ΣₗR(l)) computations of [symbol] w, φ [symbol] . To save computation, the maximum values in the above equations are obtained by searching through not the whole search space {1, . . . , R(l)×L but a subspace of lower resolution −{1, dₗ, 2dₗ, . . . , R(l)×L, where dₗ>1 is the search resolution for the phone l (longer-length phones have larger dₗ than shorter-length phones).

Such a parameter w may be estimated by a Structured Support Vector Machine (S-SVM). FIG. 4 is a diagram showing large margin training for estimating the parameter w. The S-SVM is intended to find w for maximizing a separation margin, and will be schematically described below.

The S-SVM optimizes the parameter w by minimizing a second-order objective function under the terms of combinations of linear margin constraints, as given by the following Equation (5):

$${min}_{w , ξ} \frac{1}{2} {‖ w ‖}^{2} + \frac{C}{N} {\sum }_{i = 1}^{N} {ξ}_{i} \\ s . t . 〈 w , Δ Φ ( {X}_{i} , y ) 〉 \geq Δ ( {y}_{i} , y ) - {ξ}_{i} \\ {ξ}_{i} \geq 0 , ∀ i , ∀ y ∈ y \backslash {y}_{i} \qquad ( 5 )$$

where

$$\begin{matrix}〈 w , Δ Φ ( {x}_{i} , y ) 〉 = F ( {X}_{i} , {y}_{i} ; w ) - F ( {X}_{i} , y ; w ) \\ = 〈 w , Φ ( {x}_{i} , {y}_{i} ) - Φ ( {x}_{i} , y ) 〉 ,\end{matrix}$$

C is greater than 0 and denotes a constant for controlling a trade-off between the maximization of a margin and the minimization of an error, and ξᵢ denotes a slack variable.

In this case, F(Xᵢ, yᵢ; w)−F(Xᵢ, y; w) (margin) is, for example, a difference between a correct phonetic sequence and any phonetic sequence and is configured to be maximized. Accordingly, such w as to maximize the difference is obtained.

During a procedure for maximizing the difference, a loss function Δ(yᵢ, y) for scaling a difference between y and yᵢ function is taken into consideration. The loss refers to a criterion for indicating how the correct label and any label are different from each other.

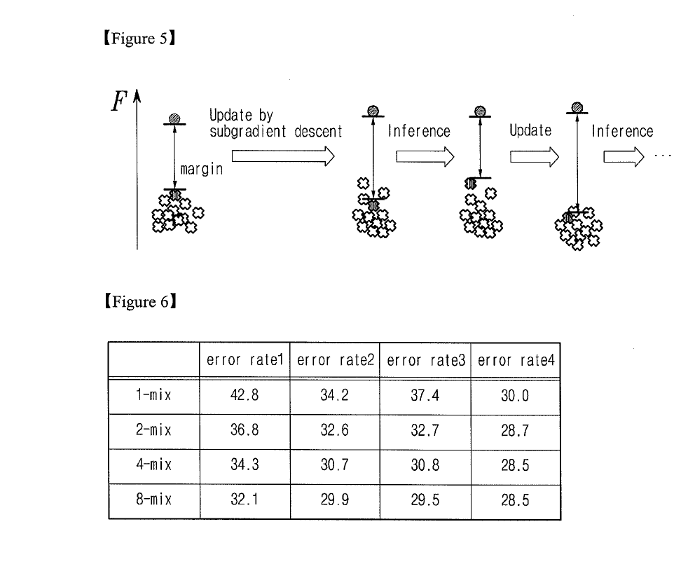

Here, since the S-SVM has a larger number of margin constraints, it is difficult to solve the above Equation (5). Therefore, part of the constraints are reduced using a stochastic subgradient descent algorithm that has been proposed by F. Sha and entitled “Large margin training of acoustic models for speech recognition,” in a Ph. D. thesis, Univ. Pennsylvania, 2007, and by N. Ratliff, J. A. Bagnell, and M. Zinkevich and entitled “(online) subgradient methods for structured prediction,” in AISTATS, 2007. Thereafter, as shown in FIG. 5, constraints are additionally and repeatedly applied one by one to Equation (5), and then w is updated. For example, if there are 100 constraints, w is updated while the constraints are added 100 times one by one.

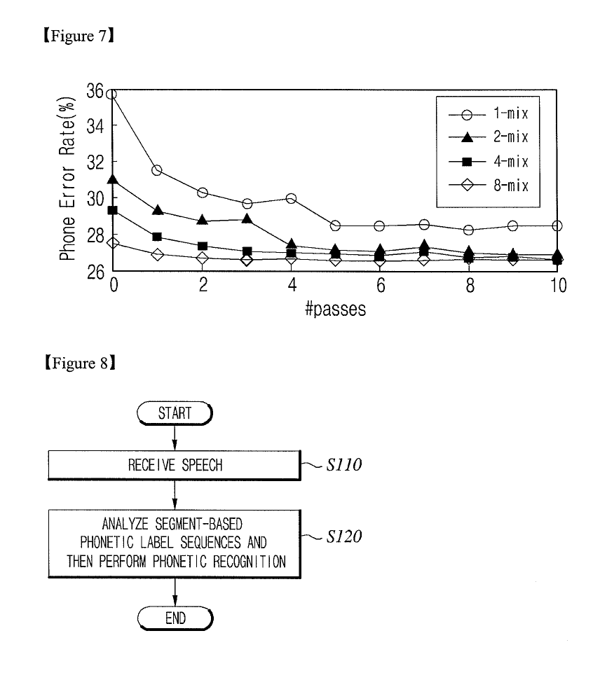

FIGS. 6 and 7 are diagrams showing an error rate when the phonetic recognition model according to the embodiment of the present invention is used.

Referring to FIG. 6, it can be seen through experimentation that the error rate obtained when the phonetic recognition model according to the embodiment of the present invention is used (that is, error rate 4) is lower than error rates obtained when various conventional phonetic recognition models are used (that is, error rate 1, error rate 2, and error rate 3).

Referring to FIG. 7, it can be seen that as the number of mixtures is larger, the error rate decreases, and that as the number of passes increases, the error rate decreases. In FIGS. 6 and 7, each of 1-mix, 2-mix, 4-mix, and 8-mix denotes the number of Gaussian mixtures of the content feature.

FIG. 8 is a flowchart showing a phonetic recognition method according to an embodiment of the present invention. The phonetic recognition method may be performed by the speech recognition system 10, shown in FIG. 2.

Referring to FIG. 8, the phonetic data recognition device 20 of the speech recognition system 10 receives speech in step S110. The phonetic data recognition device configures speech data from the received speech and outputs the speech data to the phonetic data processing device 30.

The phonetic data processing device 30 analyzes segment-based phonetic label sequences from the received speech data and then performs phonetic recognition in step S120. The analysis of the phonetic label sequences may be performed based on Equations (1) to (5), as described above.

The method of the present invention can be implemented in the form of computer-readable code stored in a computer-readable recording medium. The code may enable the microprocessor of a computer.

The computer-readable recording medium includes all types of recording devices that store data readable by a computer system.

Examples of the computer-readable recording medium include Read Only Memory (ROM), Random Access Memory (RAM), Compact Disc ROM (CD-ROM), magnetic tape, a floppy disc, an optical data storage device, etc. Further, the program code for performing the phonetic recognition method according to the present invention may be transmitted in the form of a carrier wave (for example, via transmission over the Internet).

Furthermore, the computer-readable recording medium may be distributed across computer systems connected to each other over a network and may be stored and executed as computer-readable code in a distributed manner. Furthermore, the functional program, code, and code segments for implementing the present invention may be easily inferred by programmers skilled in the art to which the present invention pertains.

According to the phonetic recognition method, the system for processing the method, and the recording medium for storing the method in accordance with the present invention, there are advantages in that continuous phonetic recognition can be more easily performed and in that an error rate can be decreased.

Although the preferred embodiments of the present invention have been disclosed for illustrative purposes, those skilled in the art will appreciate that various changes, modifications, and additions are possible, without departing from the scope and spirit of the invention as disclosed in the accompanying claims. Therefore, it should be understood that those changes, modifications and additions belong to the scope of the accompanying claims.

What is claimed is:

1. A phonetic recognition method of recognizing phones using a speech recognition system, comprising:
by a phonetic data recognition device, receiving speech; and
by a phonetic data processing device, recognizing phones from the received speech using a semi-Markov model.

2. The phonetic recognition method according to claim 1, wherein in the recognizing the phones, a phonetic label sequence is represented by <function 1> given by the following equation:
$$\hat{y} = arg {max}_{y ∈ y} F ( X , y ; w ) = arg {max}_{y ∈ y} 〈 w , φ ( x , y ) 〉 \qquad 〈 function 1 〉$$
where ŷ denotes a phonetic label sequence, y denotes a set of phonetic label sequences, x denotes an acoustic feature vector, y denotes a phonetic label, w denotes a parameter, and φ(x, y) denotes a segment-based joint feature map.

3. The phonetic recognition method according to claim 2, wherein the segment-based joint feature map comprises:
$$\begin{matrix}Φ ( X , y ) = {\sum }_{j = 1}^{J} φ ( {l}_{j - 1} , {l}_{j} , {n}_{j - 1} , {n}_{j} , {\{ x \}}_{j} ) \\ = {\sum }_{j = 1}^{J} [ \begin{matrix}\begin{matrix}{φ}^{transition} ( {l}_{j - 1} , {l}_{j} ) \\ {φ}^{duration} ( {n}_{j - 1} , {n}_{j} , {l}_{j} )\end{matrix} \\ {φ}^{content} ( {\{ x \}}_{j} , {n}_{j - 1} , {n}_{j} , {l}_{j} )\end{matrix} ]\end{matrix}$$
where lⱼ denotes a label of a j-th phone segment, nⱼ denotes a last frame index of the j-th phone segment, J denotes a number of segments, {x}ⱼ denotes an acoustic feature vector of observation of the j-th phone segment, φ^{transition}(lⱼ₋₁, lⱼ) denotes a transition feature indicating a relationship between a relevant phone and its subsequent phone when the relevant phone is present on a just previous label, φ_{duration}(nⱼ₋₁, nⱼ, lⱼ) denotes a (nⱼ₋₁-nⱼ) duration feature indicating a duration of the relevant phone (for example, for the label lⱼ), and φ^{content}({x}ⱼ, nⱼ₋₁, nⱼ, lⱼ) denotes a content feature indicating acoustic feature data.

4. The phonetic recognition method according to claim 3, wherein the transition feature is represented by a Kronecker delta function.

5. The phonetic recognition method according to claim 3, wherein the duration feature is defined as sufficient statistics of gamma distribution.

6. The phonetic recognition method according to claim 3, wherein the content feature is represented by the following equation:
$${φ}_{( l , k )}^{content} ( {\{ x \}}_{j} , {n}_{j - 1} , {n}_{j} , {l}_{j} ) = \frac{B ( l )}{{n}_{j} - {n}_{j - 1 }} {\sum }_{t ∈ {s}_{j , k}} vec ( [ \begin{matrix}{x}_{t} {x}_{t}^{T} & {x}_{t} \\ {x}_{t}^{T} & 1\end{matrix} ] ) δ ( {l}_{j} = l )$$
where l denotes a phone, k denotes a bin index, B(l) denotes a number of bins corresponding to a phonetic label l, bₖ is
$${b}_{k} = \{ {n}_{j - 1} + \frac{{n}_{j} - {n}_{j - 1}}{B ( l )} ( k - 1 ) + 1 , … , {n}_{j - 1} + \frac{{n}_{j} - {n}_{j - 1}}{B ( l )} k \}$$
(where kε{1, . . . , B(l)}), and δ(lⱼ=l) denotes a Kronecker delta function.

7. The phonetic recognition method according to claim 6, wherein the <function 1> is represented by the following equation:
$$U ( t , l ) = {argmax}_{( d , {l}^{′} ) ∈ \{ 1 , … , R ( l ) \} \times ℒ} ( V ( t - d , {l}^{′} ) + 〈 w , φ ( {l}^{′} , l , t - d , t , X ) 〉 )$$
$$V ( t , l ) = {max}_{( d , {l}^{′} ) ∈ \{ 1 , … , R ( l ) \} \times ℒ} ( V ( t - d , {l}^{′} ) + 〈 w , φ ( {l}^{′} , l , t - d , t , X ) 〉 )$$
(here, V(t,l) is the maximal score for all partial segmentations such that the last segment ends at the t-th frame with label l, U(t,l) is a tuple of length d and previous label l′ occupied by the best path where phone l′ transits to phone l at time t-d and R(l) is the range of admissible durations of phone l to ensure tractable inference).

8. The phonetic recognition method according to claim 6, wherein the parameter w is estimated by a Structured Support Vector Machine (S-SVM).

9. The phonetic recognition method according to claim 8, wherein the S-SVM is solved using a stochastic subgradient descent algorithm.

10. A recording medium for storing a computer program for performing the phonetic recognition method set forth in claim 1.

11. A speech recognition system for recognizing phones, comprising:
a phonetic data recognition device for receiving speech, configuring speech data from the speech, and outputting the speech data; and
a phonetic data processing device for recognizing phones from output signals of the phonetic data recognition device using a semi-Markov model.

12. The speech recognition system according to claim 11, wherein a phonetic label sequence is represented by <function 1> given by the following equation:
$$\hat{y} = arg {max}_{y ∈ y} F ( X , y ; w ) = arg {max}_{y ∈ y} 〈 w , φ ( x , y ) 〉 \qquad 〈 function 1 〉$$
where ŷ denotes a phonetic label sequence, y denotes a set of phonetic label sequences, x denotes an acoustic feature vector, y denotes a phonetic label, w denotes a parameter, and φ(x, y) denotes a segment-based joint feature map.

13. The speech recognition system according to claim 12, wherein the segment-based joint feature map comprises:
$$\begin{matrix}Φ ( X , y ) = {\sum }_{j = 1}^{J} φ ( {l}_{j - 1} , {l}_{j} , {n}_{j - 1} , {n}_{j} , {\{ x \}}_{j} ) \\ = {\sum }_{j = 1}^{J} [ \begin{matrix}\begin{matrix}{φ}^{transition} ( {l}_{j - 1} , {l}_{j} ) \\ {φ}^{duration} ( {n}_{j - 1} , {n}_{j} , {l}_{j} )\end{matrix} \\ {φ}^{content} ( {\{ x \}}_{j} , {n}_{j - 1} , {n}_{j} , {l}_{j} )\end{matrix} ]\end{matrix}$$
where lⱼ denotes a label of a j-th phone segment, nⱼ denotes a last frame index of the j-th phone segment, J denotes a number of segments, {x}ⱼ denotes an acoustic feature vector of observation of the j-th phone segment, φ^{transition}(lⱼ₋₁, lⱼ) denotes a transition feature indicating a relationship between a relevant phone and its subsequent phone when the relevant phone is present on a just previous label, φ^{duration}(nⱼ₋₁, nⱼ, lⱼ) denotes a (nⱼ₋₁-nⱼ) duration feature indicating a duration of the relevant phone (for example, for the label lⱼ), and φ^{content}({x}ⱼ, nⱼ₋₁, nⱼ, lⱼ) denotes a content feature indicating acoustic feature data.

14. The speech recognition system according to claim 13, wherein the content feature is represented by the following equation:
$${φ}_{( l , k )}^{content} ( {\{ x \}}_{j} , {n}_{j - 1} , {n}_{j} , {l}_{j} ) = \frac{B ( l )}{{n}_{j} - {n}_{j - 1}} {\sum }_{t ∈ {s}_{j , k}} vec ( [ \begin{matrix}{x}_{t} {x}_{t}^{T} & {x}_{t} \\ {x}_{t}^{T} & 1\end{matrix} ] ) δ ( {l}_{j} = l )$$
where l denotes a phone, k denotes a bin index, B(l) denotes a number of bins corresponding to a phonetic label l, bₖ is
$${b}_{k} = \{ {n}_{j - 1} + \frac{{n}_{j} - {n}_{j - 1}}{B ( l )} ( k - 1 ) + 1 , … , {n}_{j - 1} + \frac{{n}_{j} - {n}_{j - 1}}{B ( l )} k \}$$
(where kε{1, . . . , B(l)}), and δ(lⱼ=l) denotes a Kronecker delta function.

15. The speech recognition system according to claim 14, wherein the <function 1> is represented by the following equation:
$$U ( t , l ) = {argmax}_{( d , {l}^{′} ) ∈ \{ 1 , … , R ( l ) \} \times ℒ} ( V ( t - d , {l}^{′} ) + 〈 w , φ ( {l}^{′} , l , t - d , t , X ) 〉 )$$
$$V ( t , l ) = {max}_{( d , {l}^{′} ) ∈ \{ 1 , … , R ( l ) \} \times ℒ} ( V ( t - d , {l}^{′} ) + 〈 w , φ ( {l}^{′} , l , t - d , t , X ) 〉 )$$
(here, V(t,l) is the maximal score for all partial segmentations such that the last segment ends at the t-th frame with label l, U(t,l) is a tuple of length d and previous label l′ occupied by the best path where phone l′ transits to phone l at time t-d and R(l) is the range of admissible durations of phone l to ensure tractable inference).

16. The speech recognition system according to claim 14, wherein the parameter w is estimated by a Structured Support Vector Machine (S-SVM).

17. The speech recognition system according to claim 16, wherein the S-SVM is solved using a stochastic subgradient descent algorithm.
